(19) United States
(12) Patent Application Publication
(10) Pub. No.: US 2010/0134928 A1
(43) Pub. Date: Jun. 3, 2010

(54) HEAD SUSPENSION ASSEMBLY AND STORAGE MEDIUM DRIVING APPARATUS

(75) Inventors: Yusuke NOJIMA, Tokyo (JP); Shinji KOGANEZAWA, Atsugi-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/698,916

(22) Filed: Feb. 2, 2010

Related U.S. Application Data
(63) Continuation of application No. PCT/JP2007/065304, filed on Aug. 3, 2007.

(51) Int. Cl. G11B 21/24

(52) U.S. Cl. 360/294.4; G9B/21.028

(57) ABSTRACT

According to one embodiment, a head suspension assembly includes: a head slider; a fixed piece supported on a surface of a platy gimbal; a first arm configured to extend from the fixed piece, be connected to the head slider, and include a platy first flexible portion that extends, between the fixed piece and the head slider, along a first virtual plane perpendicular to the surface of the gimbal; a second arm configured to extend from the fixed piece, be connected to the head slider, and include a platy second flexible portion configured to extend along a second virtual plane that is perpendicular to the surface of the gimbal and that intersects with the first virtual plane at an intersection angle less than 180 degrees; a first piezoelectric element joined to the first flexible portion; and a second piezoelectric element joined to the second flexible portion.

### CROSS-REFERENCE TO RELATED APPLICATIONS

This application is a continuation of PCT international application Ser. No. PCT/JP2007/065304 filed on Aug. 3, 2007 which designates the United States, the entire contents of which are incorporated herein by reference.

### BACKGROUND

1. Field

One embodiment of the invention relates to a head suspension assembly that is incorporated into a storage medium driving apparatus such as a hard disk drive (HDD).

2. Description of the Related Art

As disclosed in Japanese Patent Application Publication (KOKAI) No. 2002-74870, for example, head suspension assemblies having actuators are widely known. In such a head suspension assembly, a head slider is supported by a first arm piece and a second arm piece. The first arm piece and the second arm piece extend parallel to each other. A piezoelectric element is attached to each of the arm pieces. As the piezoelectric elements expand and contract, the first arm piece and the second arm piece bend. Based on the bending of the first arm piece and the second arm piece, the head slider is displaced in the track width direction on a recording disk.

In such an actuator, the first arm piece and the second arm piece each bend in a S-shaped form. The head slider is linearly displaced in the track width direction of the recording track. The amount of such linear displacement cannot be as large as expected (see also Japanese Patent No. 2528261).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view schematically illustrating the inner structure of a hard disk drive (HDD) as a specific example of a storage medium driving apparatus;

FIG. 2 is an exemplary enlarged perspective view schematically illustrating the structure of the floating head slider;

FIG. 3 is an exemplary enlarged perspective view schematically and partially illustrating the structure of a head suspension assembly according to a first embodiment of the invention;

FIG. 4 is an exemplary enlarged plan view schematically illustrating the structure of the microactuator unit;

FIG. 5 is an exemplary enlarged plan view schematically illustrating the operation of the microactuator unit;

FIG. 6 is an exemplary enlarged plan view schematically illustrating an analytical model of the microactuator unit;

FIG. 7 is a graph representing the relationship between the intersection angle and the displacement of the electromagnetic conversion device;

FIG. 8 is an exemplary enlarged perspective view schematically illustrating the structure of a head suspension assembly according to a second embodiment of the invention;

FIG. 9 is an exemplary enlarged and exploded perspective view schematically illustrating the structure of an oscillating member according to a modification;

FIG. 10 is an exemplary enlarged plan view of a microactuator unit, schematically illustrating the structures of the first piezoelectric element and the second piezoelectric element according to the modification; and

FIG. 11 is an exemplary enlarged plan view of a microactuator unit, schematically illustrating the structures of the first piezoelectric element and the second piezoelectric element according to another modification.

### DETAILED DESCRIPTION

Various embodiments according to the invention will be described hereinafter with reference to the accompanying drawings. In general, according to one embodiment of the invention, a head suspension assembly, comprises: a head slider; a fixed piece configured to be supported on a surface of a platy gimbal; a first arm piece configured to extend from the fixed piece, be connected to the head slider, and include a platy first flexible portion that extends, between the fixed piece and the head slider, along a first virtual plane perpendicular to the surface of the gimbal; a second arm piece configured to extend from the fixed piece, be connected to the head slider, and include a platy second flexible portion configured to extend along a second virtual plane that is perpendicular to the surface of the gimbal and that intersects with the first virtual plane at an intersection angle less than 180 degrees; a first piezoelectric element configured to be joined to the first flexible portion; and a second piezoelectric element configured to be joined to the second flexible portion.

According to another embodiment of the invention, a storage medium driving apparatus, comprises: a head slider; a fixed piece configured to be supported on a surface of a platy gimbal; a first arm piece configured to extend from the fixed piece, be connected to the head slider, and include a platy first flexible portion that extends, between the fixed piece and the head slider, along a first virtual plane perpendicular to the surface of the gimbal; a second arm piece configured to extend from the fixed piece, be connected to the head slider, and include a platy second flexible portion configured to extend along a second virtual plane that is perpendicular to the surface of the gimbal and that intersects with the first virtual plane at an intersection angle less than 180 degrees; a first piezoelectric element configured to be joined to the first flexible portion; a second piezoelectric element configured to be joined to the second flexible portion; and a suspension configured to support the gimbal.

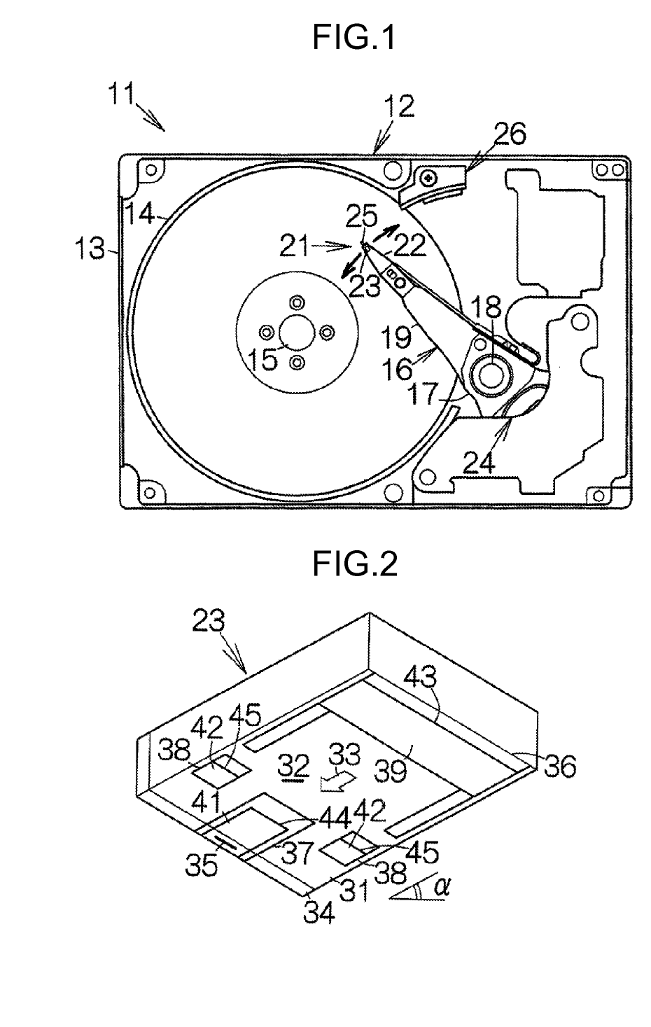

FIG. 1 schematically illustrates the inner structure of a specific example of a storage medium driving apparatus according to the invention, or a hard disk drive (HDD) 11. This HDD 11 comprises a housing 12. The housing 12 is formed with a box-like base 13 and a cover (not illustrated in FIG. 1). The base 13 defines an internal space of a flat parallelepiped or a housing space, for example. The base 13 is molded from a metal material such as aluminum with the use of a cast, for example. The cover is joined to the opening of the base 13. The housing space is hermetically closed between the cover and the base 13. The cover is molded from a single board by pressing, for example.

One or more magnetic disks 14 as storage media are accommodated in the housing space. The magnetic disks 14 are attached to the rotational axis of a spindle motor 15. The spindle motor 15 can rotate the magnetic disks 14 at high speeds such as 400 rpm, 7200 rpm, 10000 rpm, and 15000 rpm, for example.

A carriage 16 is also accommodated in the housing space. The carriage 16 comprises a carriage block 17. The carriage block 17 is rotatably joined to a spindle 18 extending in the vertical direction. A plurality of carriage arms 19 horizontally extending from the spindle 18 are compartmentalized in the carriage block 17. The carriage block 17 may be molded from aluminum by extrusion, for example.

Ahead suspension assembly 21 is attached to the top end of each of the carriage arms 19. Each head suspension assembly 21 comprises a head suspension 22 extending forward from the top end of each corresponding carriage arm 19. Flexer is applied to the head suspension 22. As will be described later, a gimbal is compartmentalized in the flexer at the top end of the head suspension 22. A floating head slider 23 is mounted on the gimbal. By virtue of the gimbal, the floating head slider 23 can change the position of the head suspension 22. A magnetic head or an electromagnetic conversion device is mounted on the floating head slider 23.

Since each magnetic disk 14 rotates, an air current is generated on the surface of the magnetic disk 14. Because of the air current, positive pressure or buoyancy and negative pressure is applied to the floating head slider 23. The buoyancy and negative pressure balance with the pressing force from the head suspension 22. With this arrangement, each floating head slider 23 can continue to float with relatively high rigidity, while the magnetic disk 14 is rotating.

A power source such as a voice coil motor (VCM) 24 is connected to the carriage block 17. By virtue of the VCM 24, the carriage block 17 can rotate about the spindle 18. The rotation of the carriage block 17 causes the carriage arm 19 and the head suspension 22 to swing. When the carriage arm 19 swings about the spindle 18 while the floating head slider 23 is floating, the floating head slider 23 can radially move across the surface of the magnetic disk 14. Based on the movement of the floating head slider 23, the electromagnetic conversion device can be positioned onto a target recording track.

A load tab 25 that is a long rectangular member extending forward from the top end of the head suspension 22 is compartmentalized at the top end of the head suspension 22. Based on the swing of the carriage arm 19, the load tab 25 can move in the radial direction of the magnetic disk 14. A lump member 26 is provided on the moving route of the load tab 25 and is located outside the magnetic disk 14. The load tab 25 is stopped by the lump member 26. The lump member 26 and the load tab 25 cooperate with each other, and form a load/unload mechanism. The lump member 26 may be molded from a hard-plastic material, for example.

FIG. 2 illustrates a specific example of the floating head slider 23. This floating head slider 23 comprises a flat parallelepiped base member or a slider body 31, for example. The slider body 31 may be made of a hard nonmagnetic material such as Al₂O₃—TiC (AlTiC). The slider body 31 faces the magnetic disk 14 on the medium facing surface or a floating face 32. A flat base surface or a reference surface is formed in the floating face 32. When the magnetic disk 14 rotates, an air current 33 flowing from the front end to the rear end of the slider body 31 acts on the floating face 32.

An insulating nonmagnetic film or a device embedding film 34 is stacked on the end face on the air outlet side of the slider body 31. An electromagnetic conversion device 35 is embedded into the device embedding film 34. The device embedding film 34 may be made of an insulating nonmagnetic material that is relatively soft, such as Al₂O₃ (alumina). The floating head slider 23 is formed with a femto slider, for example. Accordingly, the length of the floating head slider 23 in the longitudinal direction is set at 0.85 mm. The width of the floating head slider 23 in the width direction perpendicular to the longitudinal direction is set at 0.7 mm. The thickness of the floating head slider 23 is set at 0.23 mm.

A single front rail 36 starts from the base surface on the upstream side of the air current 33 or the air inlet side is formed on the floating face 32. The front rail 36 extends along the air inlet end of the base surface in the slider width direction. Likewise, a rear center rail 37 that starts from the base surface on the downstream side of the air current 33 or the air outlet side is formed on the floating face 32. The rear center rail 37 is located at the center position in the slider width direction. The rear center rail 37 reaches the device embedding film 34. A pair of rear side rails 38 are further formed on the floating face 32. The rear side rails 38 start from the base face on the air outlet side, extending along the side ends of the slider body 31. The rear center rail 37 is located between the rear side rails 38.

So-called air bearing surfaces (ABS) 39, 41, and 42 are formed on the top faces of the front rail 36, the rear center rail 37, and the rear side rails 38, respectively. The air inlet ends of the air bearing surfaces 39, 41, and 42 are connected to the top faces of the front rail 36, the rear center rail 37, and the rear side rails 38 at steps 43, 44, and 45. When the air current 33 is stopped by the floating face 32, the steps 43, 44, and 45 causes relatively large positive pressure or buoyancy to act on the air bearing surfaces 39, 41, and 42. Further, large negative pressure is generated on the rear side or at the back of the front rail 36. Based on the balance between the buoyancy and the negative pressure, the floating state of the floating head slider 23 is secured.

The electromagnetic conversion device 35 is buried in the rear center rail 37 on the air outlet side of the air bearing surfaces 42. The electromagnetic conversion device 35 comprises a writing device and a reading device. A so-called thin-film magnetic head is used as the writing device. The thin-film magnetic head generates a magnetic field from a thin-film coil pattern. Information is written on the magnetic disk 14 by virtue of the magnetic field. Meanwhile, a giant magnetoresistive (GMR) device or a tunnel magnetoresistive (TMR) device is used as the reading device. In the GMR device of the TMR device, resistance changes are caused in the spin valve film and the tunnel junction film, depending on the orientation of the magnetic field generated from the magnetic disk 14. Based on such resistance changes, information is read from the magnetic disk 14. The electromagnetic conversion device 35 faces the read gap of the reading device and the write gap of the writing device to the surface of the device embedding film 34. A hard protection film may be formed on the surface of the device embedding film 34 on the air outlet side of the air bearing surface 42. Such a hard protection film covers the top end of the write gap and the top end of the read gap that expose through the surface of the device embedding film 34. The protection film may be a DLC (diamond-like carbon) film, for example. However, the floating head slider 23 is not limited to the above structure.

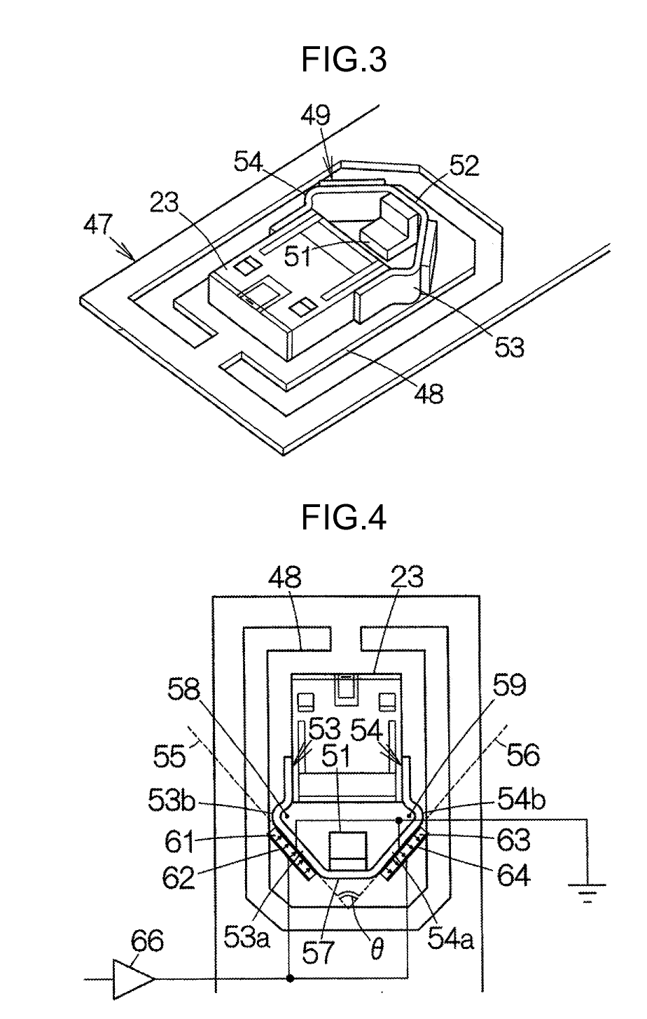

FIG. 3 schematically illustrates the head suspension assembly 21 according to a first embodiment of the invention. As illustrated in FIG. 3, a platy gimbal 48 is compartmentalized in a flexer 47. A microactuator unit 49 is attached onto the surface of the gimbal 48. The floating head slider 23 is supported by the microactuator unit 49. As will be described later, by virtue of the microactuator unit 49, the floating head slider 23 can be slightly displaced along the surface of the gimbal 48 in the slider width direction perpendicular to the center line extending in the longitudinal direction of the floating head slider 23.

The microactuator unit 49 comprises a fixed piece 51 that is fixed onto the surface of the gimbal 48. An oscillating member 52 is joined to the fixed piece 51. The oscillating member 52 may be molded from a metal plate such as a stainless steel plate. The molding may be performed through a bending process. Alternatively, the oscillating member 52 may be molded from zircon or ceramic. Here, the oscillating member 52 has at least conductivity.

A first arm piece 53 and a second arm piece 54 are compartmentalized in the oscillating member 52. The first arm piece 53 extends from the fixed piece 51 and is connected to the floating head slider 23 at its top end. The second arm piece 54 extends from the fixed piece 51 and is connected to the floating head slider 23 at its top end. The floating head slider 23 is interposed between the top end of the first arm piece 53 and the top end of the second arm piece 54.

As can be seen from FIG. 4, a first flexible portion 53a is compartmentalized in the first arm piece 53. The first flexible portion 53a is located between the fixed piece 51 and the floating head slider 23, and spreads over a first virtual plane 55 that is perpendicular to the surface of the gimbal 48. Likewise, a second flexible portion 54a is compartmentalized in the second arm piece 54. The second flexible portion 54a is located between the fixed piece 51 and the floating head slider 23, and spreads over a second virtual plane 56 that is perpendicular to the surface of the gimbal 48. The second virtual plane 56 intersects with the first virtual plane 55 at an intersection angle θ that is smaller than 180 degrees. Here, the intersection angle θ is set at 80 degrees, for example. A joining part 57 is formed between the first arm piece 53 and the second arm piece 54 in the oscillating member 52. The joining part 57 spreads over a plane that is perpendicular to the center line in the longitudinal direction of the floating head slider 23. The first arm piece 53 and the second arm piece 54 extend from the joining part 57. The joining part 57 is joined to the fixed piece 51.

A first curved plate portion 53b is formed between the first flexible portion 53a and the floating head slider 23 in the first arm piece 53. The first curved plate portion 53b is curved around an axis line 58 extending parallel to the first virtual plane 55. The first curved plate portion 53b is curved outward around the axis line 58. Likewise, a second curved plate portion 54b is formed between the second flexible portion 54a and the floating head slider 23 in the second arm piece 54. The second curved plate portion 54b is curved around an axis line 59 extending parallel to the second virtual plane 56. The second curved plate portion 54b is curved outward around the axis line 59. Since the first curved plate portion 53b and the second curved plate portion 54b are formed, the lengths of the first flexible portion 53a and the second flexible portion 54a can be made longer.

A first piezoelectric element 61 is formed on a surface that is the outer surface of the first flexible portion 53a. The first piezoelectric element 61 spreads over the entire length of the first flexible portion 53a. The first piezoelectric element 61 may be formed with a piezoelectric ceramic thin plate of a predetermined thickness, for example. The piezoelectric ceramic thin plate may be molded from a piezoelectric material such as PNN-PT-PZ. An electrode 62 is formed on a surface that is the outer surface of the first piezoelectric element 61. The piezoelectric ceramic thin plate is sandwiched between the electrode 62 and the surface of the first flexible portion 53a.

Likewise, a second piezoelectric element 63 is formed on a surface that is the outer surface of the second flexible portion 54a. The second piezoelectric element 63 spreads over the entire length of the second flexible portion 54a. The second piezoelectric element 63 may be formed with a piezoelectric ceramic thin plate of a predetermined thickness, for example. The piezoelectric ceramic thin plate may be molded from a piezoelectric material such as PNN-PT-PZ. An electrode 64 is formed on a surface that is the outer surface of the second piezoelectric element 63. The piezoelectric ceramic thin plate is sandwiched between the electrode 64 and the surface of the second flexible portion 54a.

As illustrated in FIG. 4, for example, the first piezoelectric element 61 is polarized from the electrode 62 toward the surface of the first flexible portion 53a. The second piezoelectric element 63 is polarized from the surface of the second flexible portion 54a toward the electrode 64. Accordingly, when a positive driving voltage is applied to the electrodes 62 and 64 of the first and second piezoelectric elements 61 and 63, the first piezoelectric element 61 contracts along the surface of the first flexible portion 53a, and the second piezoelectric element 63 expands along the surface of the second flexible portion 54a. When a negative driving voltage is applied to the electrodes 62 and 64 of the first and second piezoelectric elements 61 and 63, the first piezoelectric element 61 expands along the surface of the first flexible portion 53a, and the second piezoelectric element 63 contracts along the surface of the second flexible portion 54a. Upon application of a driving voltage, a wiring pattern (not illustrated) made of a conductive material is formed on the surface of the flexer 47. Such a wiring pattern connects the electrodes 62 and 64 to a voltage supply 66. Here, the oscillating member 52 may be grounded. Alternatively, the oscillating member 52 may be connected to a grounding pattern (not illustrated) made of a conductive material formed on the surface of the flexer 47.

While the magnetic disk 14 is rotating, the floating head slider 23 faces the surface of the magnetic disk 14 upon writing or reading of magnetic information. Here, air bearings are formed between the surface of the magnetic disk 14 and the air bearing surfaces 39, 41, and 42 of the floating head slider 23. The floating head slider 23 floats above the surface of the magnetic disk 14. By virtue of the VCM 24, the electromagnetic conversion device 35 is positioned to a target recording track. After that, the electromagnetic conversion device 35 continues to follow the target recording track, under tracking servo control.

Under the tracking servo control, the reading device of the electromagnetic conversion device 35 reads desired magnetic information from the magnetic disk 14. Based on the magnetic information, the distance between the center line of the recording track and the reading device of the electromagnetic conversion device 35 is measured. A voltage to be applied is then generated in accordance with the distance. The voltage to be applied is applied from the voltage supply 66 to the electrodes 62 and 64 of the first and second piezoelectric elements 61 and 63.

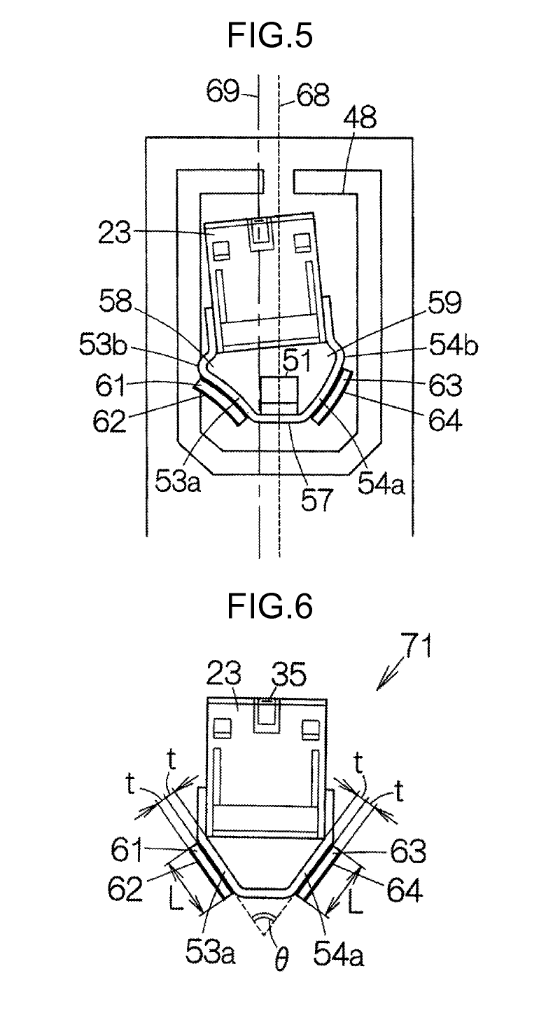

As illustrated in FIG. 5, for example, a center line 69 of the recording track might deviate in a first direction from a center line 68 running in the longitudinal direction of the gimbal 48. When a positive applied voltage is applied to the electrodes 62 and 64, the first piezoelectric element 61 contracts along the surface of the first flexible portion 53a. As a result, the first flexible portion 53a bends away from the second flexible portion 54a. Meanwhile, the second piezoelectric element 63 expands over the surface of the second flexible portion 54a. As a result, the second flexible portion 54a bends toward the first flexible portion 53a. In this manner, the floating head slider 23 swings counterclockwise around a swing axis line that extends parallel to the first and second virtual planes 55 and 56 on the air inlet side of the floating head slider 23. The electromagnetic conversion device 35 is displaced toward the center line of the recording track.

In a case where the centerline 69 of the recording track deviates in a second direction that is the opposite direction of the first direction with respect to the center line 68 of the gimbal 68, when a negative applied voltage is applied to the electrodes 62 and 64, the first piezoelectric element 61 expands over the surface of the first flexible portion 53a. As a result, the first flexible portion 53a bends toward the second flexible portion 54a. Meanwhile, the second piezoelectric element 63 contracts along the surface of the second flexible portion 54a. As a result, the second flexible portion 54a bends away from the first flexible portion 53a. In this manner, the floating head slider 23 swings clockwise around a swing axis line that extends parallel to the first and second virtual planes 55 and 56 on the air inlet side of the floating head slider 23. The electromagnetic conversion device 35 is displaced toward the center line of the recording track.

Since the electromagnetic conversion device 35 moves away from the swing axis line to the maximum extent in the floating head slider 23, the electromagnetic conversion device 35 can move a great distance when the first and second flexible portions 53a and 54a swing. In other words, by virtue of the swing, the displacement of the electromagnetic conversion device 35 can be made larger. In this manner, the amount of displacement of the electromagnetic conversion device 35 per unit driving voltage can be increased. When the electromagnetic conversion device 35 is displaced, the driving voltage can be restricted to a smallest possible value.

The inventor verified the advantages of the microactuator unit 49. To perform the verification, the inventor conducted simulation experiments based on computer software. As illustrated in FIG. 6, for example, the inventor constructed an analytical model 71 of the microactuator unit 49, to perform the simulations. This analytical model 71 does not comprise the first and second curved plate portions 53b and 54b. The length L of each of the first and second flexible portions 53a and 54a was set at 0.4 mm. The length L of each of the first and second flexible portions 53a and 54a was defined between the fixed piece 51 and the floating head slider 23. The voltage to be applied to the first and second piezoelectric elements 61 and 63 was set at 100 V. A stainless steel plate was selected as the material of the oscillating member 52. The thicknesses of the first and second piezoelectric elements 61 and 63, and the oscillating member 52 were set at 50 μm. The inventor arbitrarily changed the value of the intersection angle θ. To maintain the length L, the length of the joining part 57 was adjusted.

The inventor calculated the amount of displacement of the electromagnetic conversion device 35 in the slider width direction that is perpendicular to the center line extending in the longitudinal direction of the floating head slider 23. As a result, the inventor confirmed that the amount of displacement of the electromagnetic conversion device 35 increased as the intersection angle θ increased from 0 degrees to 120 degrees, as indicated in Table 1. At the same time, the inventor measured the in-plane main resonance frequency over the surface of the gimbal 48. The inventor confirmed that the in-lane main resonance frequency decreased as the intersection angle θ increased from 0 degrees to 120 degrees.

TABLE 1

| | Thickness t of | Electromagnetic | |
|---|---|---|---|
| | flexible portion | conversion | Main |
| Intersection | Thickness t of | device | resonance |
| angle θ | piezoelectric | displacement | frequency |
| [degree] | element [μm] | [nm] | [kHz] |
| 0 | 50 | 135 | 96.7 |
| 20 | 50 | 197 | 76.0 |
| 40 | 50 | 299 | 61.6 |
| 80 | 50 | 536 | 45.3 |
| 120 | 50 | 601 | 39.0 |

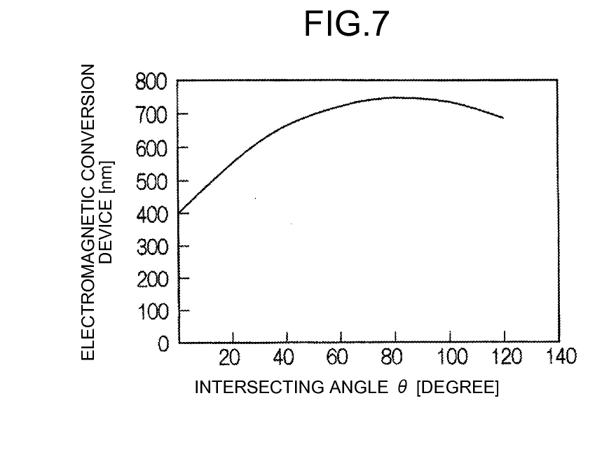

The inventor then adjusted the thickness t of the oscillating member 52 and the thickness t of each of the first and second piezoelectric elements 61 and 63, with respect to each intersection angle θ. Based on the adjustment of each thickness t, the in-plane resonance frequency was adjusted to a value in the neighborhood of 35 kHz, with respect to each intersection angle θ. As a result, the largest amount of displacement was secured when the intersection angle θ was in the neighborhood of 80 degrees, as is apparent from Table 2 and FIG. 7.

TABLE 2

| | Thickness t of | Electromagnetic | |
|---|---|---|---|
| | flexible portion | conversion | Main |
| Intersection | Thickness t of | device | resonance |
| angle θ | piezoelectric | displacement | frequency |
| [degree] | element [μm] | [nm] | [kHz] |
| 0 | 20 | 431 | 33.3 |
| 20 | 25 | 532 | 33.7 |
| 40 | 30 | 661 | 34.0 |
| 80 | 40 | 745 | 36.6 |
| 120 | 45 | 685 | 36.1 |

Here, the width of the femto slider is fixed to 0.7 mm, as described above. Therefore, where the intersection angle θ is set at 80 degrees, the length L of each of the first and second flexible portions 53a and 54a is fixed to a predetermined value. In the microactuator unit 49 described above, the first and second curved plate portions 53b and 54b are formed on the oscillating member 52. By virtue of the first and second curved plate portions 53b and 54b, the length L of each of the first and second flexible portions 53a and 54a can become greater. Since the length L of each of the first and second flexible portions 53a and 54a becomes greater, the electromagnetic conversion device 35 can be displaced efficiently when the first and second flexible portions 53a and 54a bend.

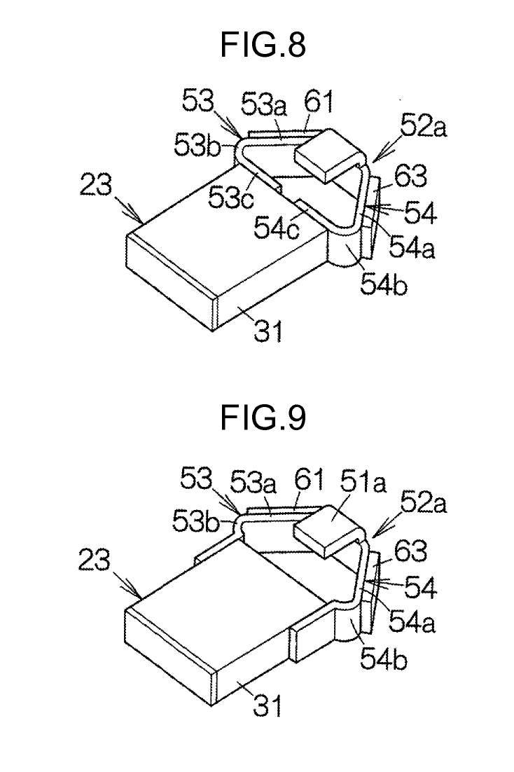

FIG. 8 schematically illustrates the structure of the head suspension assembly 21 according to a second embodiment of the invention. This head suspension assembly 21 has a first flat plate part 53c and a second flat plate part 54c formed at the top ends of the first arm piece 53 and the second arm piece 54. The first and second flat plate parts 53c and 54c extends over a virtual plane that is perpendicular to the center line extending in the longitudinal direction of the floating head slider 23. The first and second flat plate parts 53c and 54c are connected to the first and second flexible portions 53a and 54a via the first and second curved plate portions 53b and 54b, respectively. The first and second flat plate parts 53c and 54c connect an oscillating member 52a to the floating head slider 23. In this manner, the oscillating member 52a is fixed to the end face of the floating head slider 23 or the slider body 31 on the air inlet side. With this oscillating member 52a being fixed, the first and second flat plate parts 53c and 54c may be simply stacked on the air-inlet-side end face of the slider body 31. The floating head slider 23 does not need to be interposed between the first arm piece 53 and the second arm piece 54. The fixing of the oscillating member 52a is relatively easy. In FIG. 8, the components having the same effects and functions as those of the first embodiment are denoted by the same reference numerals as those used in the first embodiment.

As illustrated in FIG. 9, a fixed piece 51a may be integrally formed with the above oscillating members 52 or 52a. The fixed piece 51a may be formed from a metal plate at the time of bending processing of the oscillating member 52 or 52a. Accordingly, the procedure for forming the oscillating member 52 or 52a can be omitted, and the processing costs can be made lower.

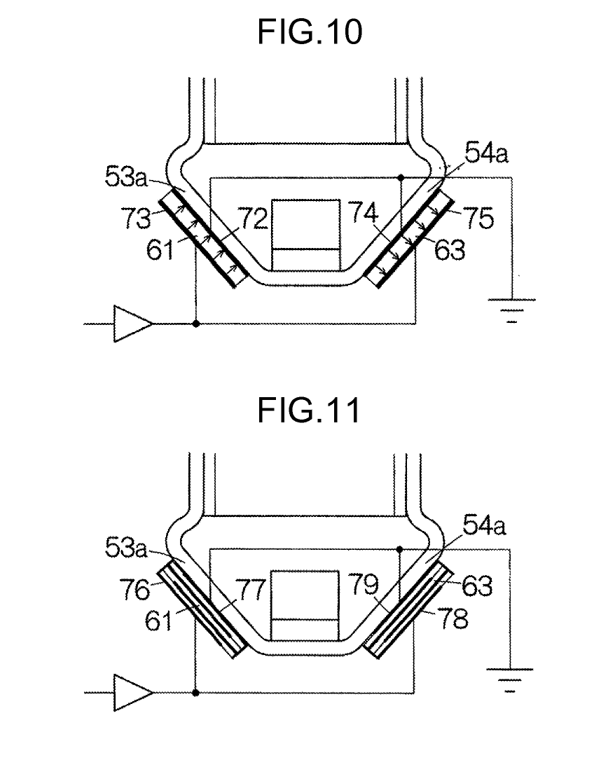

As illustrated in FIG. 10, the first piezoelectric element 61 may be interposed between a first electrode layer 72 and a second electrode layer 73 that are conductive and are supported on the surface of the first flexible portion 53a. The first piezoelectric element 61 is polarized from the second electrode layer 73 toward the first electrode layer 72. Meanwhile, the second piezoelectric element 63 may be interposed between a third electrode layer 74 and a fourth electrode layer 75 that are conductive and are supported on the surface of the second flexible portion 54a. The second piezoelectric element 63 is polarized from the third electrode layer 74 toward the fourth electrode layer 75. Here, a driving voltage is applied to the second electrode layer 73 and the fourth electrode layer 75. The first electrode layer 72 and the third electrode layer 74 are grounded. A grounding pattern (not illustrated) made of a conductive material may be formed on the surface of the flexer 47. In such a case, the first electrode layer 72 and the third electrode layer 74 are grounded to the grounding pattern, and the oscillating member 52 does not necessarily have conductivity.

Alternatively, as illustrated in FIG. 11, the first piezoelectric element 61 may be formed with a plurality of first piezoelectric thin films, and the second piezoelectric element 63 may be formed with a plurality of second piezoelectric thin films. The first piezoelectric thin films and the second piezoelectric thin films may be molded from the above mentioned piezoelectric material. In such a case, first and second conductive electrode layers 76 and 77 are alternately interposed between the first piezoelectric thin films in the first piezoelectric element 61. Each of the first piezoelectric thin films should be polarized from the first electrode layer 76 toward the second electrode layer 77. Likewise, third and fourth conductive electrode layers 78 and 79 are alternately interposed between the second piezoelectric thin films in the second piezoelectric element 63. Each of the second piezoelectric thin films should be polarized from the fourth electrode layer 79 toward the third electrode layer 78. Here, a driving voltage is applied to each first electrode layer 76 and each third electrode layer 78. Each second electrode layer 77 and each fourth electrode layer 79 are grounded.

According to an embodiment of the invention, the first flexible portion curves correspondingly with the contraction and expansion of the first piezoelectric element. Similarly, the second flexible portion curves correspondingly with the contraction and expansion of the second piezoelectric element. The head slider is thus displaced along the surface of the gimbal. Upon the displacement, the head slider swings around the swing axis line extending parallel to the first and second virtual planes. Therefore, it is possible to ensure a large displacement at a position maximally distant from the swing axis line. It is possible to amplify the displacement with the swing.

According to an embodiment of the invention, the first and second curved plate portions are able to expand outwardly around the axis lines. Therefore, it is possible to increase the length of the first and second flexible portions. When the length of the first and second flexible portions is thus increased, the head slider is able to be efficiently displaced upon curving of the first and second flexible portions. Further, it is possible to increase the length of the first and second piezoelectric elements based on the increase in the length of the first and second flexible portions. As a result, it is possible to increase the displacement of the head slider even more.

According to an embodiment of the invention, voltage is applied from the first and second electrode layers to the first and second piezoelectric elements. In accordance with the application of voltage, it is possible to control expansion and contraction of the first and second piezoelectric elements.

According to an embodiment of the invention, voltage is applied from the first and second electrode layers to the first piezoelectric element. Similarly, voltage is applied from the third and fourth electrode layers to the second piezoelectric element. In accordance with the application of voltage, it is possible to control expansion and contraction of the first and second piezoelectric elements.

According to an embodiment of the invention, voltage is applied from the first and second electrode layers to the first piezoelectric thin films. Similarly, voltage is applied from the third and fourth electrode layers to the second piezoelectric thin films. In accordance with the application of voltage, it is possible to control expansion and contraction of the first and second piezoelectric elements.

The above head suspension assembly may be used in a storage medium driving apparatus. With this storage medium driving apparatus, it is possible to achieve the above effects and advantages.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head suspension assembly, comprising:
a head slider;
a fixed portion on a surface of a tabular gimbal;
a first arm extending from the fixed portion, being connected to the head slider, and comprising a tabular first flexible portion between the fixed portion and the head slider, along a first virtual plane perpendicular to the surface of the gimbal;
a second arm extending from the fixed portion, being connected to the head slider, and comprising a tabular second flexible portion along a second virtual plane perpendicular to the surface of the gimbal and crossing the first virtual plane at an intersection angle less than 180 degrees;
a first piezoelectric element attached to the first flexible portion; and
a second piezoelectric element attached to the second flexible portion.

2. The head suspension assembly of claim 1, further comprising:
a first curved plate portion in the first arm and curved around an axis line parallel to the first virtual plane between the head slider and the first flexible portion; and
a second curved plate portion in the second arm and curved around an axis line parallel to the second virtual plane between the head slider and the second flexible portion.

3. The head suspension assembly of claim 1, wherein the first arm and the second arm are comprised in a metal plate.

4. The head suspension assembly of claim 3, wherein the fixed portion is comprised in the metal plate.

5. The head suspension assembly of claim 3, further comprising:
an electrically conductive first electrode layer over a surface of the first piezoelectric element and comprising the first piezoelectric element between the first flexible portion and the first electrode layer; and
an electrically conductive second electrode layer over a surface of the second piezoelectric element and comprising the second piezoelectric element between the second flexible portion and the second electrode layer.

6. The head suspension assembly of claim 1, further comprising:
an electrically conductive first electrode layer on a surface of the first flexible portion;
an electrically conductive second electrode layer comprising the first piezoelectric element between the first electrode layer and the second electrode layer;
an electrically conductive third electrode layer on a surface of the second flexible portion; and
an electrically conductive fourth electrode layer comprising the second piezoelectric element between the third electrode layer and the fourth electrode layer.

7. The head suspension assembly of claim 1, further comprising:
a plurality of first piezoelectric thin films as the first piezoelectric element over a surface of the first flexible portion;
a first electrode layer and a second electrode layer between the first piezoelectric thin films in the first piezoelectric element;
a plurality of second piezoelectric thin films as the second piezoelectric element over a surface of the second flexible portion; and
a third electrode layer and a fourth electrode layer between the second piezoelectric thin films in the second piezoelectric element.

8. A storage medium driving apparatus, comprising:
a head slider;
a fixed portion on a surface of a platy gimbal;
a first arm extending from the fixed portion, being connected to the head slider, and comprising a tabular first flexible portion between the fixed portion and the head slider, along a first virtual plane perpendicular to the surface of the gimbal;
a second arm extending from the fixed portion, being connected to the head slider, and comprising a tabular second flexible portion along a second virtual plane perpendicular to the surface of the gimbal and crossing the first virtual plane at an intersection angle less than 180 degrees;
a first piezoelectric element attached to the first flexible portion;
a second piezoelectric element attached to the second flexible portion; and
a suspension configured to support the gimbal.

9. The storage medium driving apparatus of claim 8, further comprising:
a first curved plate portion in the first arm and curved around an axis line parallel to the first virtual plane between the head slider and the first flexible portion; and
a second curved plate portion in the second arm and curved around an axis line parallel to the second virtual plane between the head slider and the second flexible portion.

10. The storage medium driving apparatus of claim 8, wherein the first arm and the second arm piece are comprised in a metal plate.

11. The storage medium driving apparatus of claim 10, wherein the fixed portion is comprised in the metal plate.

12. The storage medium driving apparatus of claim 10, further comprising:
an electrically conductive first electrode layer over a surface of the first piezoelectric element and comprising the first piezoelectric element between the first flexible portion and the first electrode layer; and
an electrically conductive second electrode layer over a surface of the second piezoelectric element and comprising the second piezoelectric element between the second flexible portion and the second electrode layer.

13. The storage medium driving apparatus of claim 8, further comprising:
an electrically conductive first electrode layer on a surface of the first flexible portion;
an electrically conductive second electrode layer comprising the first piezoelectric element between the first electrode layer and the second electrode layer;
an electrically conductive third electrode layer on a surface of the second flexible portion; and
an electrically conductive fourth electrode layer comprising the second piezoelectric element between the third electrode layer and the fourth electrode layer.

14. The storage medium driving apparatus of claim 8, further comprising:
a plurality of first piezoelectric thin films as the first piezoelectric element over a surface of the first flexible portion;
a first electrode layer and a second electrode layer between the first piezoelectric thin films in the first piezoelectric element;
a plurality of second piezoelectric thin films as the second piezoelectric element over a surface of the second flexible portion; and
a third electrode layer and a fourth electrode layer between the second piezoelectric thin films in the second piezoelectric element.
